(19) United States
(12) Patent Application Publication
(10) Pub. No.: US 2009/0009062 A1
(43) Pub. Date: Jan. 8, 2009

(54) Electroluminescent Devices

(76) Inventors: Poopathy Kathirgamanathan, North Harrow (GB); Kumaraverl Muttulingam, Ealing (GB)

Correspondence Address: David Silverstein;Andover-IP-Law, 44 Park Street, Suite 300, Andover, MA, 01810, US

(21) Appl. No.: 11/664,851

(22) PCT Filed: Oct. 17, 2005
(86) PCT No.: PCT/GB05/04004

§ 371 Date: Apr. 7, 2007

(30) Foreign Application Priority Data
Oct. 15, 2004 (GB) 0422913.4

(51) Int. Cl. H01J 1/62

(52) U.S. Cl. 313/504

(57) ABSTRACT

An OLED with an inorganic p-type semiconductor hole transporting layer and an inorganic n-type semiconductor electron transporting layer.

The present invention relates to an electroluminescent device which can emit light of different colours.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04028, PCT/GB00/00268 describe electroluminescent complexes, structures and devices using rare earth chelates.

Typical electroluminescent devices which are commonly referred to as optical light emitting diodes (OLEDS) comprise an anode, normally of an electrically light transmitting material, a layer of a hole transmitting material, a layer of the electroluminescent material, a layer of an electron transmitting material and a metal cathode.

U.S. Pat. No. 5,128,587 discloses an electroluminescent device which consists of an organometallic complex of rare earth elements of the lanthanide series sandwiched between a transparent electrode of high work function and a second electrode of low work function with a hole conducting layer interposed between the electroluminescent layer and the transparent high work function electrode and an electron conducting layer interposed between the electroluminescent layer and the electron injecting low work function anode. The hole conducting layer and the electron conducting layer are required to improve the working and efficiency of the device. The hole conducting or transportation layer serves to transport holes and to block the electrons, thus preventing electrons from moving into the electrode without recombining with holes. The electron conducting or transporting layer serves to transport electrons and to block the holes, thus preventing holes from moving into the electrode without recombining with holes. The recombination of carriers therefore mainly or entirely takes place in the emitter layer.

As described in U.S. Pat. No. 6,333,521 this mechanism is based upon the radiative recombination of a trapped charge. Specifically, OLEDs are comprised of at least two thin organic layers between an anode and a cathode. The material of one of these layers is specifically chosen based on the material's ability to transport holes, a “hole transporting layer” (HTL), and the material of the other layer is specifically selected according to its ability to transport electrons, an “electron transporting layer” (ETL). With such a construction, the device can be viewed as a diode with a forward bias when the potential applied to the anode is higher than the potential applied to the cathode. Under these bias conditions, the anode injects holes (positive charge carriers) into the HTL, while the cathode injects electrons into the ETL. The portion of the luminescent medium adjacent to the anode thus forms a hole injecting and transporting zone while the portion of the luminescent medium adjacent to the cathode forms an electron injecting and transporting zone. The injected holes and electrons each migrate toward the oppositely charged electrode. When an electron and hole localise on the same molecule, a Frenkel exciton is formed. These excitons are trapped in the material which has the lowest energy. Recombination of the short-lived excitons may be visualized as an electron dropping from its conduction potential to a valence band, with relaxation occurring, under certain conditions, preferentially via a photoemissive mechanism.

The materials that function as the ETL or HTL of an OLED may also serve as the medium in which exciton formation and electroluminescent emission occur. Such OLEDs are referred to as having a “single heterostructure” (SH). Alternatively, the electroluminescent material may be present in a separate emissive layer between the HTL and the ETL in what is referred to as a “double heterostructure” (DH).

In a single heterostructure OLED, either holes are injected from the HTL into the ETL where they combine with electrons to form excitons, or electrons are injected from the ETL into the HTL where they combine with holes to form excitons. Because excitons are trapped in the material having the lowest energy gap, and commonly used ETL materials generally have smaller energy gaps than commonly used HTL materials, the emissive layer of a single heterostructure device is typically the ETL. In such an OLED, the materials used for the ETL and HTL should be chosen such that holes can be injected efficiently from the HTL into the ETL. Also, the best OLEDs are believed to have good energy level alignment between the highest occupied molecular orbital (HOMO) levels of the HTL and ETL materials.

In a double heterostructure OLED, holes are injected from the HTL and electrons are injected from the ETL into the separate emissive layer, where the holes and electrons combine to form excitons.

Various compounds have been used as HTL materials or ETL materials. HTL materials mostly consist of triaryl amines in various forms which show high hole mobilities (˜10⁻³ cm²/Vs). There is somewhat more variety in the ETLs used in OLEDs. Aluminum tris(8-hydroxyquinolate) (Alq₃) is the most common ETL material, and others include oxidiazol, triazol, and triazine.

A well documented cause of OLED failure is thermally induced deformation of the organic layers (e.g. melting, crystal formation, thermal expansion, etc.). This failure mode can be seen in the studies that have been carried out with hole transporting materials, K. Naito and A. Miura, J. Phys. Chem. (1993), 97, 6240-6248; S. Tokito, H. Tanaka, A. Okada and Y. Taga. Appl. Phys. Lett. (1996), 69, (7), 878-880; Y. Shirota, T Kobata and N. Noma, Chem. Lett. (1989), 1145-1148; T. Noda, L. Imae, N. Noma and Y. Shirota, Adv. Mater. (1997), 9, No. 3; E. Han, L. Do, M. Fujihira, H. Inada and Y. Shirota, J. Appl. Phys. (1996), 80, (6) 3297-701; T. Noda, H. Ogawa, N. Noma and Y. Shirota, Appl. Phys. Lett. (1997), 70, (6), 699-701; S. Van Slyke, C. Chen and C. Tang, Appl. Phys. Lett. (1996), 69, 15, 2160-2162; and U.S. Pat. No. 5,061,569.

In order to overcome this problem U.S. Pat. No. 6,333,521 discloses organic materials that are present as a glass, as opposed to a crystalline or polycrystalline form, which are disclosed for use in the organic layers of an OLED, since glasses are capable of providing higher transparency as well as producing superior overall charge carrier characteristics as compared with the polycrystalline materials that are typically produced when thin films of the crystalline form of the materials are prepared. However, thermally induced deformation of the organic layers may lead to catastrophic and irreversible failure of the OLED if a glassy organic layer is heated above its T_{g}. In addition, thermally induced deformation of a glassy organic layer may occur at temperatures lower than T_{g}, and the rate of such deformation may be dependent on the difference between the temperature at which the deformation occurs and T_{g}. Consequently, the lifetime of an OLED may be dependent on the T_{g} of the organic layers even if the device is not heated above T_{g}. As a result, there is a need for organic materials having a high T_{g} that can be used in the organic layers of an OLED.

However there is a general inverse correlation between the T_{g} and the hole transporting properties of a material, i.e., materials having a high T_{g} generally have poor hole transporting properties. Using an HTL with good hole transporting properties leads to an OLED having desirable properties such as higher quantum efficiency, lower resistance across the OLED, higher power quantum efficiency, and higher luminance.

We have now devised an electroluminescent device using HTL and/or ETLs which reduce this problem.

According to the invention there is provided an electroluminescent device which comprises (i) a first electrode (ii) a layer of an inorganic charge transporting material (iii) a layer of an organic electroluminescent material and (iv) a second electrode.

The term charge transporting material includes both hole transporting materials and electron transporting materials. When the first electrode is the anode and the second electrode is the cathode the charge transporting material will be a hole transporting material and when the first electrode is a cathode and the second electrode is the anode the charge transporting material will be an electron transporting material.

The invention also provides an electroluminescent device which comprises (i) a first electrode which is the anode (ii) a layer of an inorganic hole transporting material (HTL) (iii) a layer of an organic electroluminescent material (iv) a layer of an inorganic electron transporting material (ETL) and (v) a second electrode which is the cathode.

The transporting materials can also be called hole injectors or hole injecting materials and the term hole transporting materials (HTL) is used in this specification.

The HTLs and ETLs useful in the present invention are preferably semiconductors and semiconductors which can be used include Ge, SiC(α), AlP, AlAs, AlSb, GaP, GaAS, GaSb, InP, InAs, InSb, ZuS, ZnSe, ZnSe, ZnTe, CdS, CdTe, PbS, PbSe, PbTe.

The inorganic HTLs which can be used in the present invention are p-type semiconductors. The inorganic ETLs which can be used in the present invention are n-type semiconductors.

Some materials such as silicon, ZnS, ZnSe, CdTe and CaAs can be obtained as p-type semi conductors and n-type semiconductors and can be used in the appropriate form as HTLs and ETLs. If μₙ is greater than μₚ then the material will be a p-type material and if μₚ is greater than μₙ then the material will be an n-type semiconductor. The values of for many semicondcutors are given in “Reference data for Engineers—Semiconductors and Transistors” Section 18-7.

Examples of inorganic n-type semiconductors include n-CdSe, n-ZnSe, n-CdTe, n-ITO (indium titanium oxide), n-GaAs and n-Si.

Examples of inorganic p-type semiconductors include p-ZnS, p-ZnO, p-CdTe, p-InP, p-GaAs and p-Si.

The thickness of the inorganic HTL and the ETL layer is preferably from 2 to 100 nm and more preferably from 10 to 50 nm.

Electroluminescent compounds which can be used in the present invention are of general formula (Lα)ₙM where M is a rare earth, lanthanide or an actinide, Lα is an organic complex and n is the valence state of M.

Other organic electroluminescent compounds which can be used in the present invention are of formula

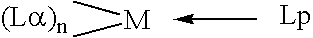

where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . . . )M(Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . . ) is equal to the valence state of the metal M. Where there are 3 groups La which corresponds to the III valence state of M the complex has the formula (L₁)(L₂)(L₃)M (Lp) and the different groups (L₁)(L₂)(L₃) may be the same or different.

Lp can be monodentate, bidentate or polydentate and there can be one or more ligands Lp.

Preferably M is metal ion having an unfilled inner shell and the preferred metals are selected from Sm(II), Eu(II), Eu(III), Tb(III), Dy(III), Yb(III), Lu(III), Gd (III), U(III), Tm(III), Ce (III), Pr(III), Nd(III), Pm(III), Ho(III), Er(III), Yb(III) and more preferably Eu(III), Tb(III), Dy(III), Gd (III), Er (III), Yt(III).

Further organic electroluminescent compounds which can be used in the present invention are of general formula (Lα)ₙM₁M₂ where M₁ is the same as M above, M₂ is a non rare earth metal, Lα is a as above and n is the combined valence state of M₁ and M₂. The complex can also comprise one or more neutral ligands Lp so the complex has the general formula (Lα)ₙ M₁ M₂ (Lp), where Lp is as above. The metal M₂ can be any metal which is not a rare earth, transition metal, lanthanide or an actinide. Examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium. titanium, vanadium, zirconium, tantalum, molybdenum, rhodium, iridium, titanium, niobium, scandium, yttrium.

For example (L₁)(L₂)(L₃)(L . . . )M (Lp) where M is a rare earth, transition metal, lanthanide or an actinide and (L₁)(L₂)(L₃)(L . . . ) and (Lp) are the same or different organic complexes.

Further organometallic complexes which can be used in the present invention are binuclear, trinuclear and polynuclear organometallic complexes e.g. of formula (Lm)ₓM₁←M₂(Ln)_{y} e.g.

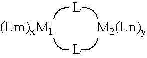

where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula

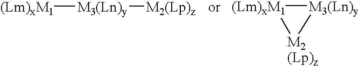

where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group.

For example the metals can be linked by bridging ligands e.g.

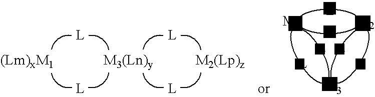

where L is a bridging ligand

By polynuclear is meant there are more than three metals joined by metal to metal bonds and/or via intermediate ligands

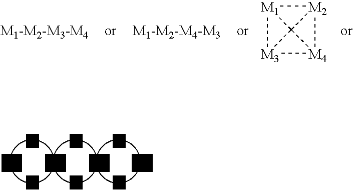

where M₁, M₂, M₃ and M₄ are rare earth metals and L is a bridging ligand.

Preferably Lα is selected from β diketones such as those of formulae

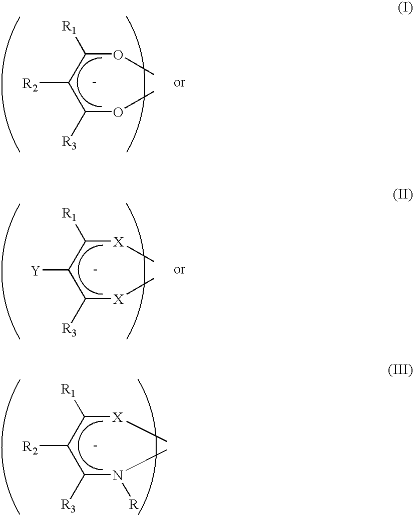

where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

The beta diketones can be polymer substituted beta diketones and in the polymer, oligomer or dendrimer substituted P diketone the substituents group can be directly linked to the diketone or can be linked through one or more —CH₂ groups i.e.

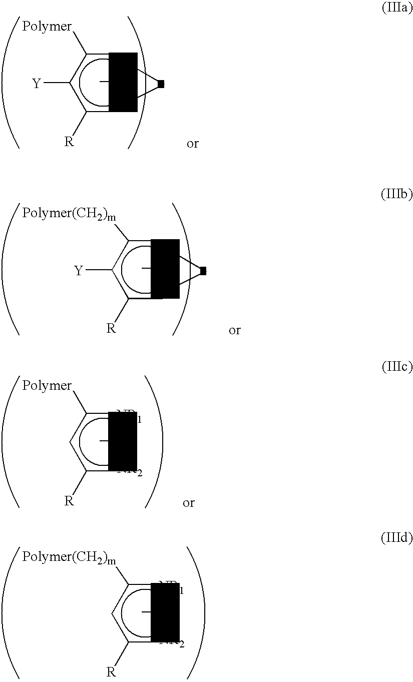

or through phenyl groups e.g.

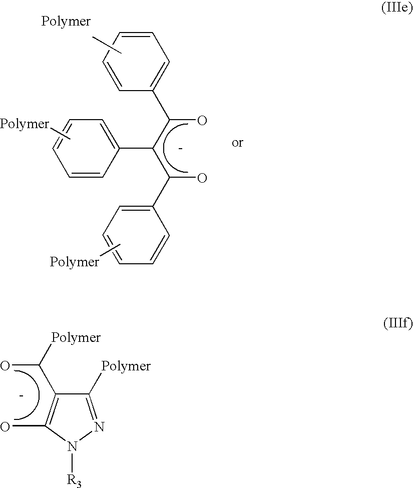

where “polymer” can be a polymer, an oligomer or a dendrimer, (there can be one or two substituted phenyl groups as well as three as shown in (IIIc)) and where R is selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups La may also be the same or different charged groups such as carboxylate groups so that the group L₁ can be as defined above and the groups L₂, L₃ . . . can be charged groups such as

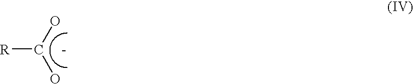

where R is R₁ as defined above or the groups L₁, L₂ can be as defined above and L₃ . . . etc. are other charged groups.

R₁, R₂ and R₃ can also be

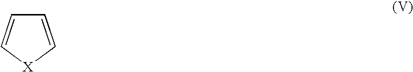

where X is O, S, Se or NH.

A preferred moiety R₁ is trifluoromethyl CF₃ and examples of such diketones are, banzoyltrifluoroacetone, p-chlorobenzoyltrifluoroacetone, 1-bromotrifluoroacetone, p-phenyltrifluoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups Lα may be the same or different ligands of formulae

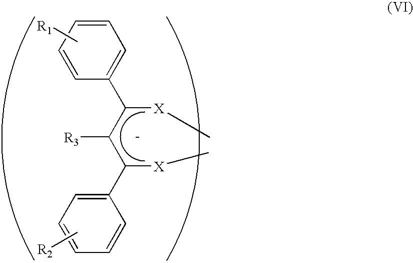

where X is O, S, or Se and R₁ R₂ and R₃ are as above.

The different groups Lα may be the same or different quinolate derivatives such as

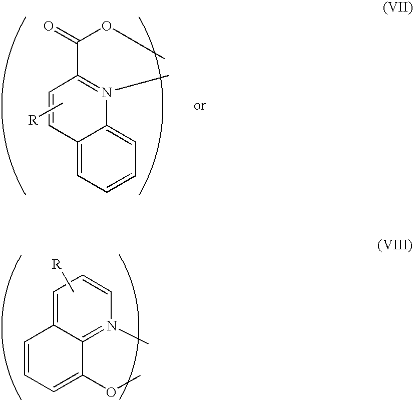

where R is hydrocarbyl, aliphatic, aromatic or heterocyclic carboxy, aryloxy, hydroxy or alkoxy e.g. the 8 hydroxy quinolate derivatives or

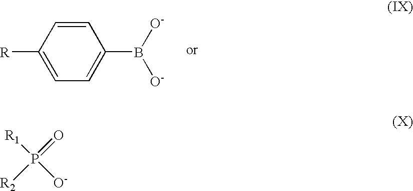

where R, R₁, and R₂ are as above or are H or F e.g. R₁ and R₂ are alkyl or alkoxy groups

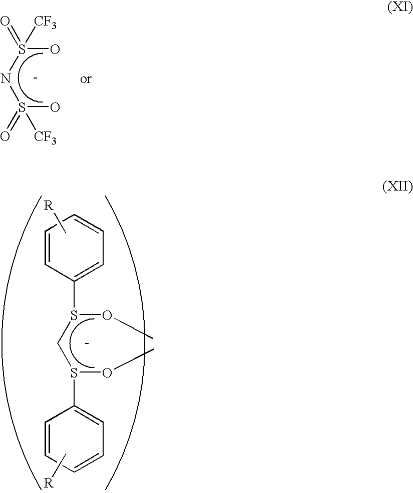

As stated above the different groups Lα may also be the same or different carboxylate groups e.g.

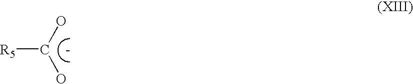

where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or La can be

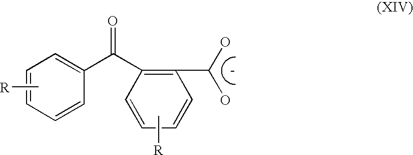

where R is as above e.g. alkyl, allenyl, amino or a fused ring such as a cyclic or polycyclic ring.

The different groups Lα may also be

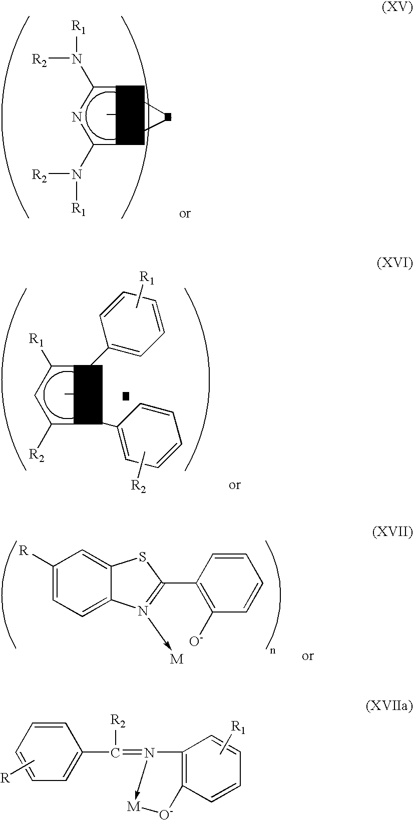

where R, R₁ and R₂ are as above.

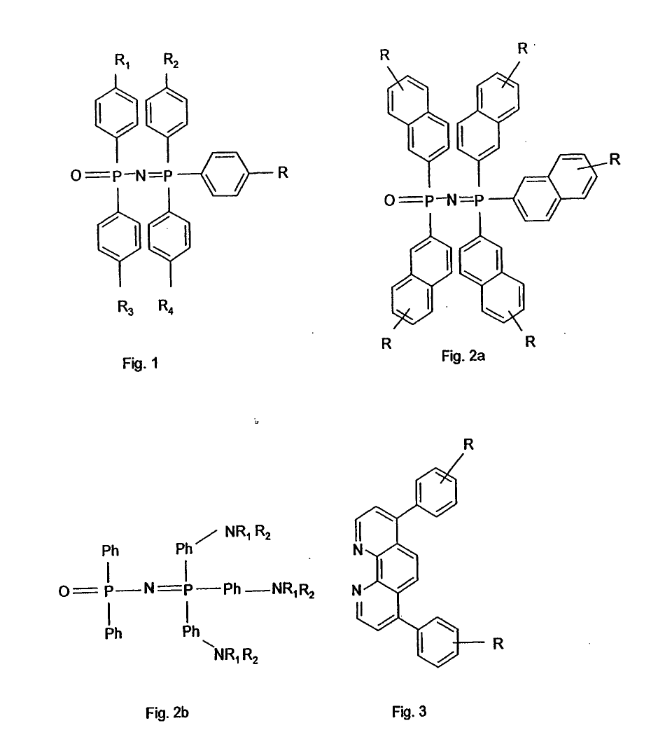

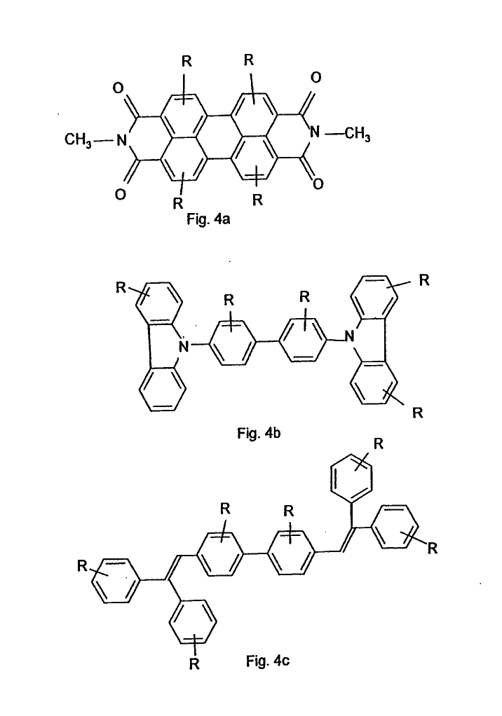

The groups L_{P} can be selected from

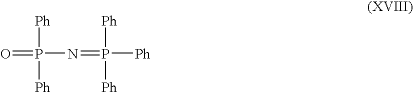

where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated allylene groups such as vinyl groups or groups

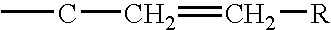

where R is as above.

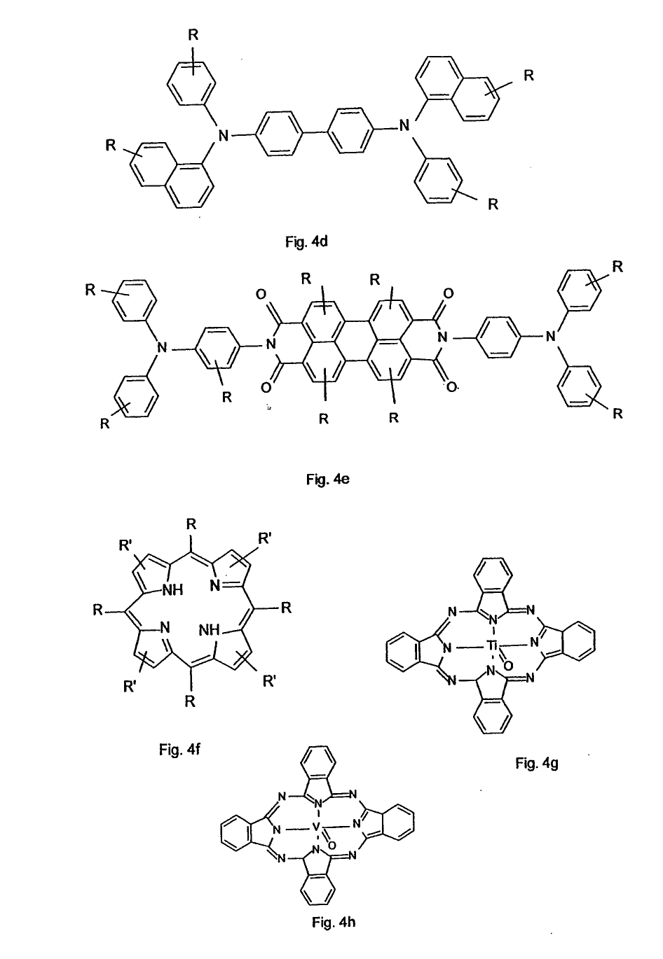

Lₚ can also be compounds of formulae

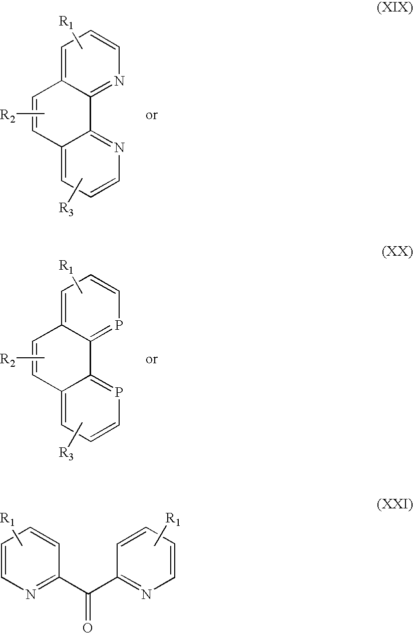

where R₁, R₂ and R₃ are as referred to above, for example bathophen shown in FIG. 3 of the drawings in which R is as above or

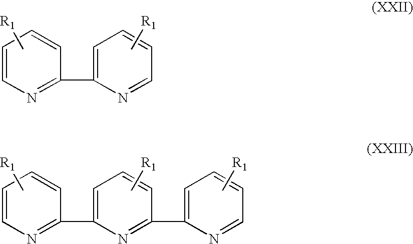

where R₁, R₂ and R₃ are as referred to above.

Lₚ can also be

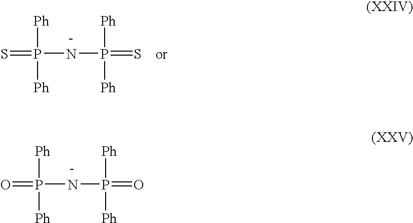

where Ph is as above.

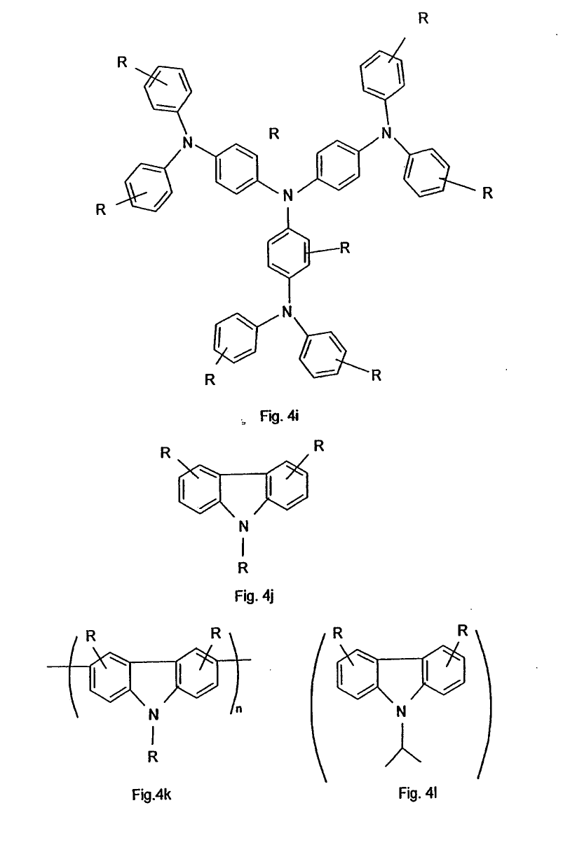

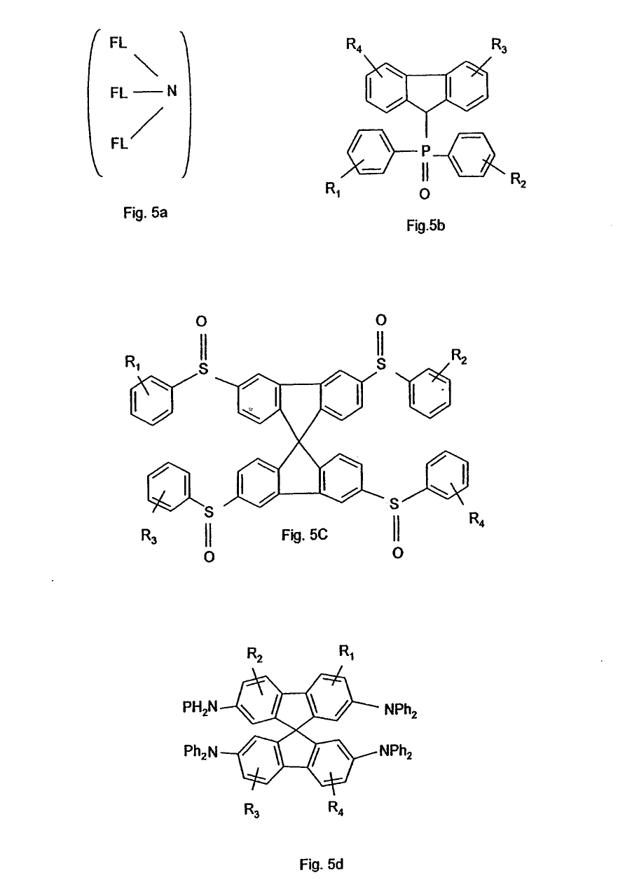

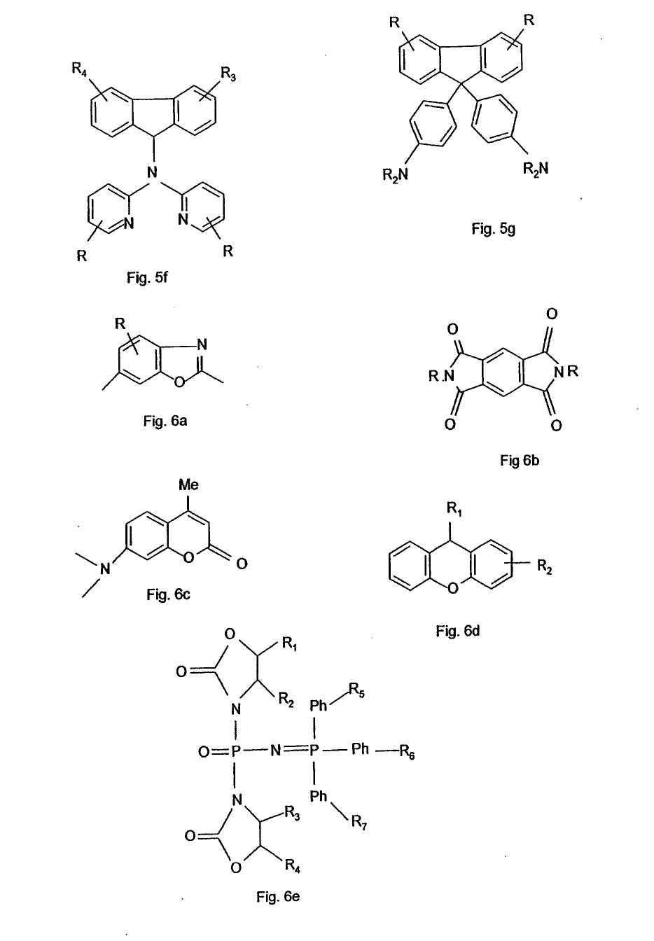

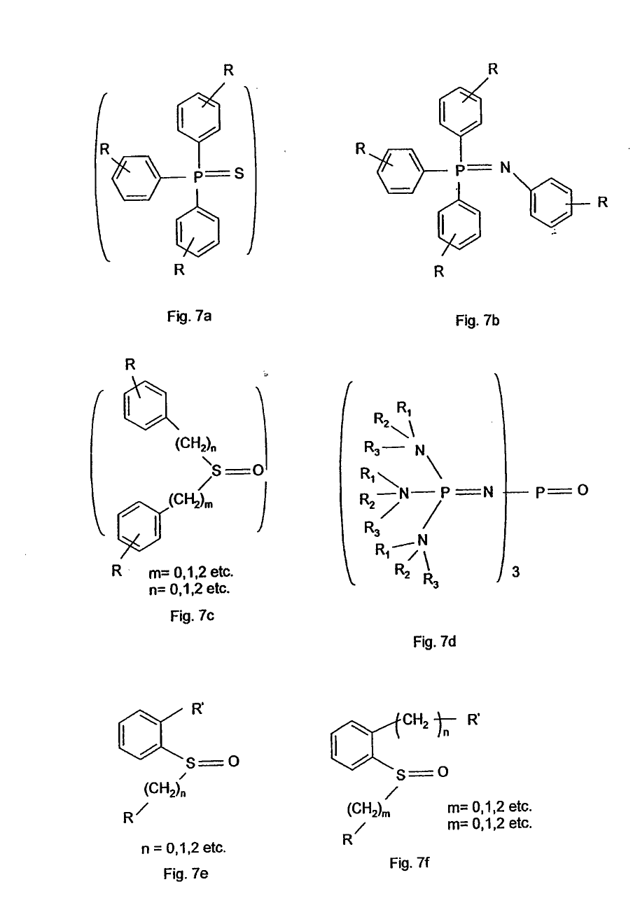

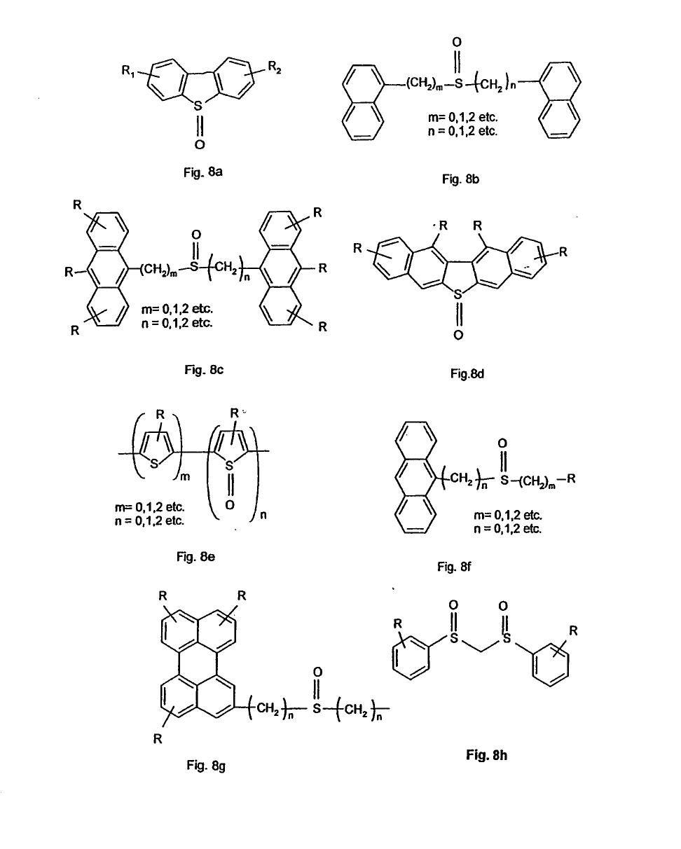

Other examples of Lp chelates are as shown in FIG. 4 and fluorene and fluorene derivatives e.g. as shown in FIG. 5 and compounds of formulae as shown in FIGS. 6 to 8.

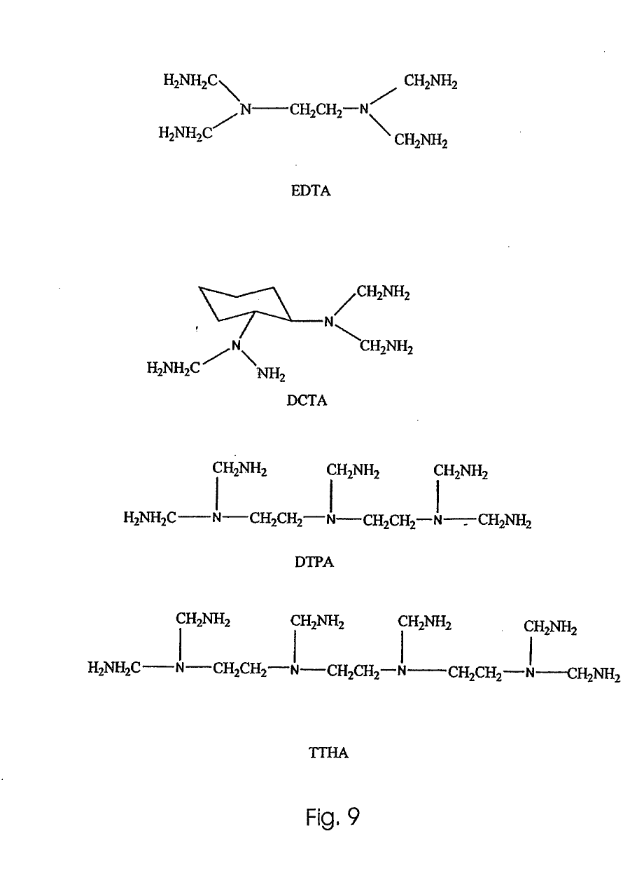

Specific examples of Lα and Lp are tripyridyl and TMHD, and TMHD complexes, α, α′, α″ tripyridyl, crown ethers, cyclans, cryptans phthalocyanans, porphoryins ethylene diamine tetramine (EDTA), DCTA, DTPA and TTHA. Where TMHD is 2,2,6,6-tetramethyl-3,5-heptanedionato and OPNP is diphenylphosphonimide triphenyl phosphorane. The formulae of the polyamines are shown in FIG. 9.

Other organic electroluminescent materials which can be used include:—

(1) metal quinolates such as lithium quinolate, and non rare earth metal complexes such as aluminium, magnesium, zinc and scandium complexes such as complexes of β-diketones e.g. Tris-(1,3-diphenyl-1-3-propanedione) (DBM) and suitable metal complexes are Al(DBM)₃, Zn(DBM)₂ and Mg(DBM)₂. Sc(DBM)₃ etc.

(2) the metal complexes of formula

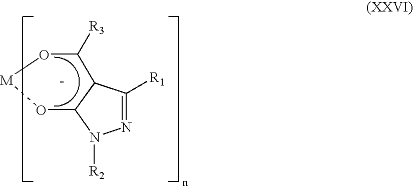

where M is a metal other than a rare earth, a transition metal, a lanthanide or an actinide; n is the valency of M; R₁, R₂ and R₃ which may be the same or different are selected from hydrogen, hydrocarbyl groups, substituted and unsubstituted aliphatic groups substituted and unsubstituted aromatic, heterocyclic and polycyclic ring structures, fluorocarbons such as trifluoryl methyl groups, halogens such as fluorine or thiophenyl groups or nitrite; R₁, and R₃ can also be form ring structures and R₁, R₂ and R₃ can be copolymerisable with a monomer e.g. styrene. Preferably M is aluminium and R₃ is a phenyl or substituted phenyl group.

(3) diiridium compounds of formula

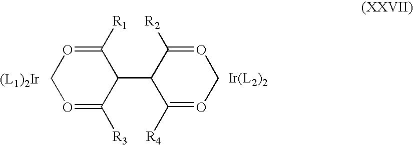

where R₁, R₂, R₃ and R₄ can be the same or different and are selected from hydrogen, and substituted and unsubstituted hydrocarbyl groups.

(4) boron compounds of formula

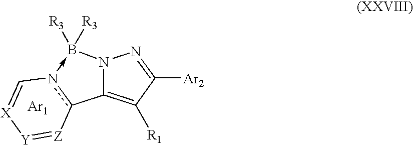

wherein Ar₁ represents a group selected from unsubstituted and substituted monocyclic or polycyclic heteroaryls having a ring nitrogen atom for forming a coordination bond to boron as indicated and optionally one or more additional ring nitrogen atoms subject to the proviso that nitrogen atoms do not occur in adjacent positions, X and Z being selected from carbon and nitrogen and Y being carbon or optionally nitrogen if neither of X and Z is nitrogen, said substituents if present being selected from substituted and unsubstituted hydrocarbyl, substituted and unsubstituted hydrocarbyloxy, fluorocarbon, halo, nitrile, amino alkylamino, dialkylamino or thiophenyl;

Ar₂ represents a group selected from monocyclic and polycyclic aryl and heteroaryl optionally substituted with one or more substituents selected from substituted and unsubstituted hydrocarbyl, substituted and unsubstituted hydrocarbyloxy, fluorocarbon, halo, nitrile, amino, alkylamino, dialkylamino and thiophenyl;

R₁ represents hydrogen or a group selected from substituted and unsubstituted hydrocarbyl, halohydrocarbyl and halo; and

R₂ and R₃ each independently represent a moiety selected from alkyl, cycloalkyl, cycloalkylalkyl, haloalkyl, halo and monocyclic, polycyclic, aryl, hetercaryl, aralkyl and heteroaralkyl optionally substituted with one or more of a moiety selected from alkyl, cycloalkyl, cycloalkylalkyl, haloalkyl, aryl, aralkyl, alkoxy, aryloxy, halo, nitric, amino, alkylamino and dialkylamino.

(5) compounds of formula

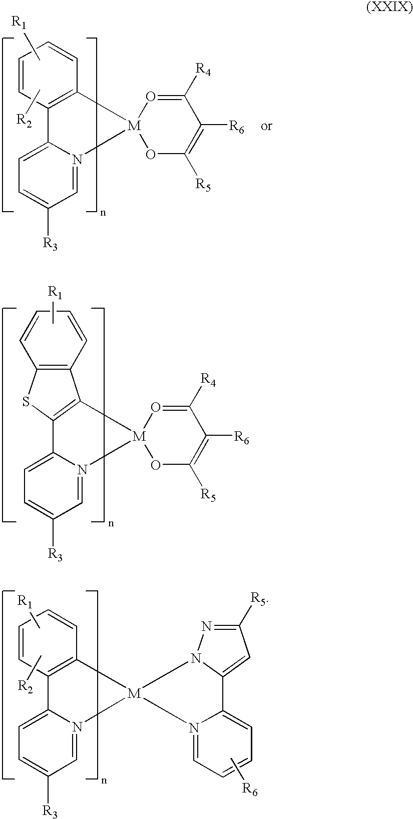

where R₁, R₂, R₃, R₄, R₅ and R₆ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene, and where R₄, and R₅ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁ R₂ and R₃ can also form substituted and unsubstituted fused aromatic, heterocyclic and polycyclic ring structures and can be copolymerisable with a monomer, M is ruthenium, rhodium, palladium, osmium, iridium or platinum and n+2 is the valency of M.

(6) electroluminescent compounds of formula

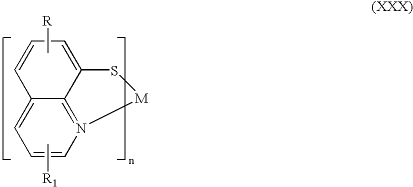

where M is a metal; n is the valency of M; R and R₁ which can be the same or different are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine; thiophenyl groups; cyano group; substituted and unsubstituted hydrocarbyl groups such as substituted and unsubstituted aliphatic groups, substituted and unsubstituted aliphatic groups.

In another electroluminescent structure the electroluminescent layer is formed of layers of two electroluminescent organic complexes in which the band gap of the second electroluminescent metal complex or organo metallic complex such as a gadolinium or cerium complex is larger than the band gap of the first electroluminescent metal complex or organo metallic complex such as a europium or terbium complex.

There can be layers of known HTLs or ETLs used in conjunction or together with the inorganic HTLs and ETLs of the present invention.

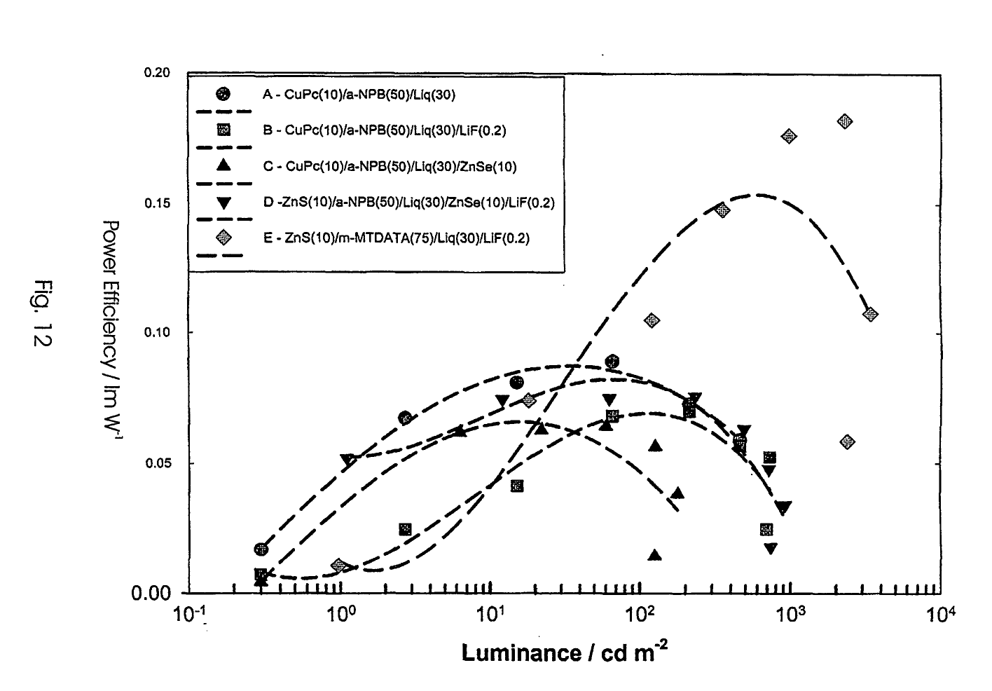

Known HTLs which can be used include polyaromatic amine complexes, such as poly(vinylcarbazole), N,N′-phenyl-N,N′-bis(3-methylphenyl)-1,1′-biphenyl-4,4′-diamine (TPD), polyaniline, and substituted polyanilines, polythiophenes, substituted polythiophenes, polysilanes and substituted polysilanes. A list of hole transporting materials is given in Patent Application WO 2004/058913 and in FIG. 12.

### EXAMPLE 1

Electroluminescent devices were fabricated by a method in which an ITO coated glass piece (1×1 cm²) cut from large sheets purchased from Balzers, (Switzerland) had a portion etched out with concentrated hydrochloric acid to remove the ITO and was cleaned. The layers forming the device were vacuum evaporated onto the ITO coated glass piece by placing the substrate in an Edwards vacuum coater and evaporating the compounds at 10⁻⁵ to 10⁻⁶ torr onto the substrate.

The coated electrodes were stored in a vacuum desiccator over calcium sulphate until they were loaded into a vacuum coater (Edwards, 10⁻⁶ torr) and aluminium top contacts made. The active area of the LED's was 0.08 cm² by 0.1 cm² the devices were then kept in a vacuum desiccator until the electroluminescence studies were performed.

The ITO electrode was always connected to the positive terminal. The current vs. voltage studies were carried out on a computer controlled Keithly 2400 source meter.

Electroluminescence spectra were recorded by means of a computer controlled charge coupled device on Insta Spec photodiode array system model 77112 (Oriel Co. Surrey, England)

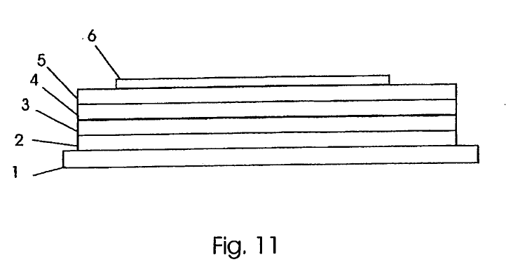

The devices had the structure of FIG. 11 in which (1) is ITO, (2) is the hole injector layer, (3) is the HTL, (4) is the electroluminescent material layer (EML), (5) is the ETL and (6) is the EIL (Electron injector layer). There was an aluminium cathode attached to the EIL. The EML was lithium quinolate made by the method described in patent application WO 00/32727.

The devices are shown in table form in Table 1 below and the colour is shown by the x,y coordinates in the CIE Chromacity Diagram (1931).

| | Hole | | | | | | |
|---|---|---|---|---|---|---|---|
| | Injector/nm | HTL/nm | EML/nm | ETL/nm | EIL/nm | | |
| Device | Layer | | | | | (x, y) | η/cd/A @ |
| ID | 2 | 3 | 4 | 5 | 6 | Colour | 100 cdm⁻² |
| A | CuPc (10) | α-NPB (50) | Liq (30) | | | 0.218, 0.407 | 0.51 |
| B | CuPc (10) | α-NPB (50) | Liq (30) | | LiF (0.2) | 0.229, 0.418 | 0.45 |
| C | CuPc (10) | α-NPB (50) | Liq (30) | ZnSe (10) | | 0.214, 0.399 | 0.41 |
| D | ZnS (10) | α-NPB (50) | Liq (30) | ZnSe (10) | LiF (0.2) | 0.227, 0.363 | 0.39 |
| E | ZnS (10) | mTADATA (75) | Liq (35) | | LiF (0.2) | 0.209, 0.398 | 0.53 |

The ZnS is p-type and the ZnSe is n-type.

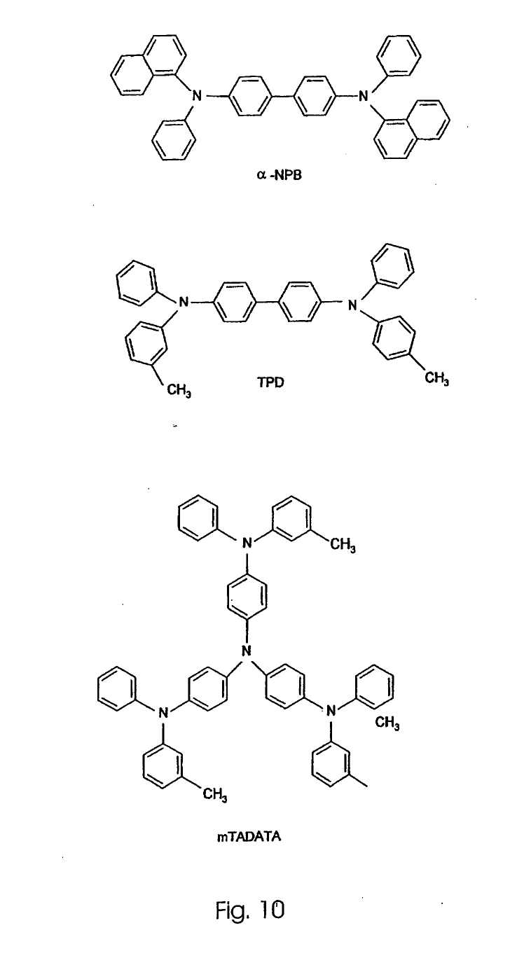

α-NPB and mMTDATA are shown in FIG. 10.

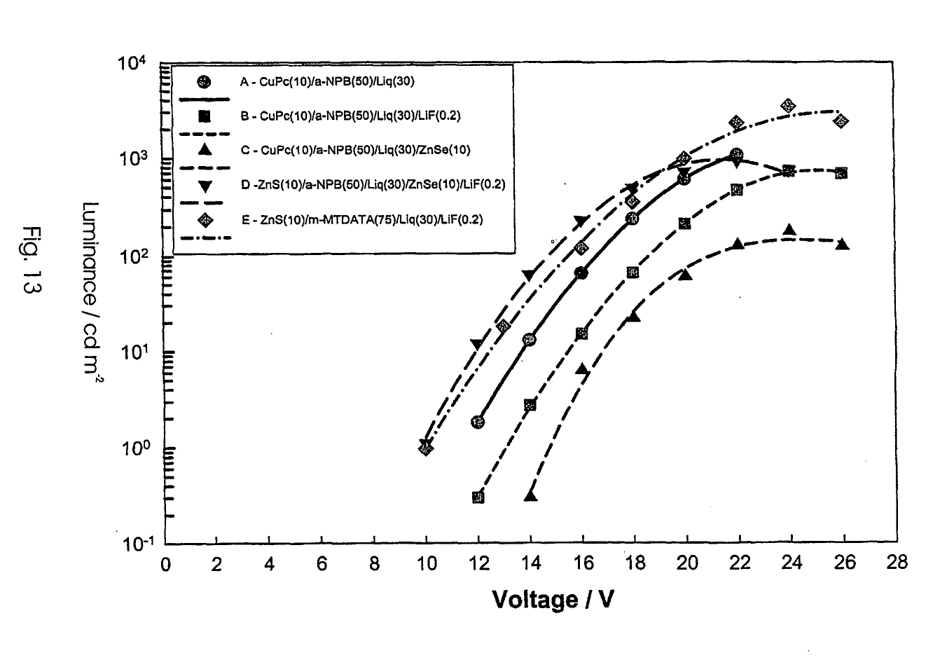

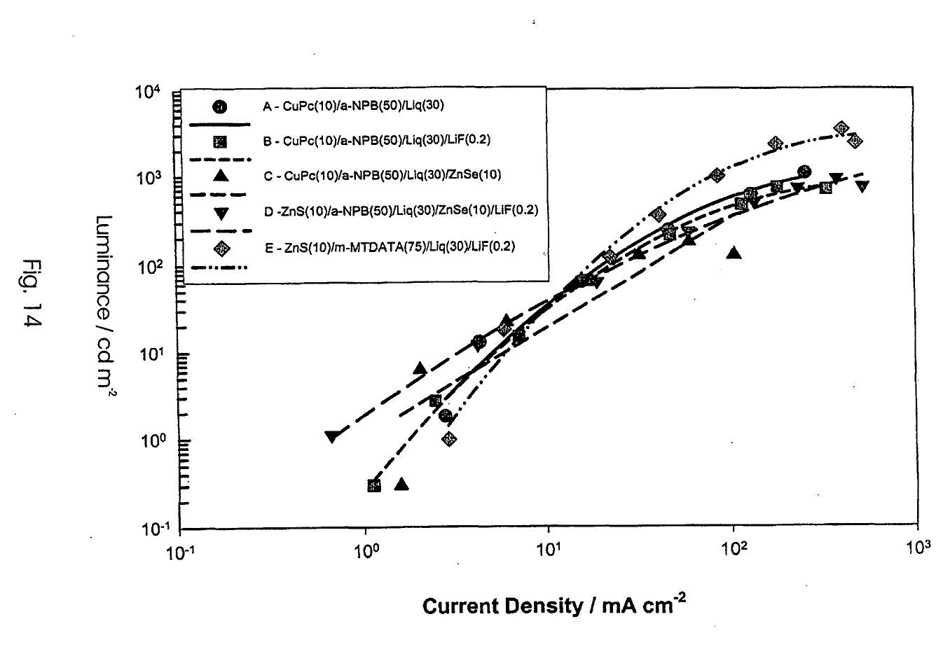

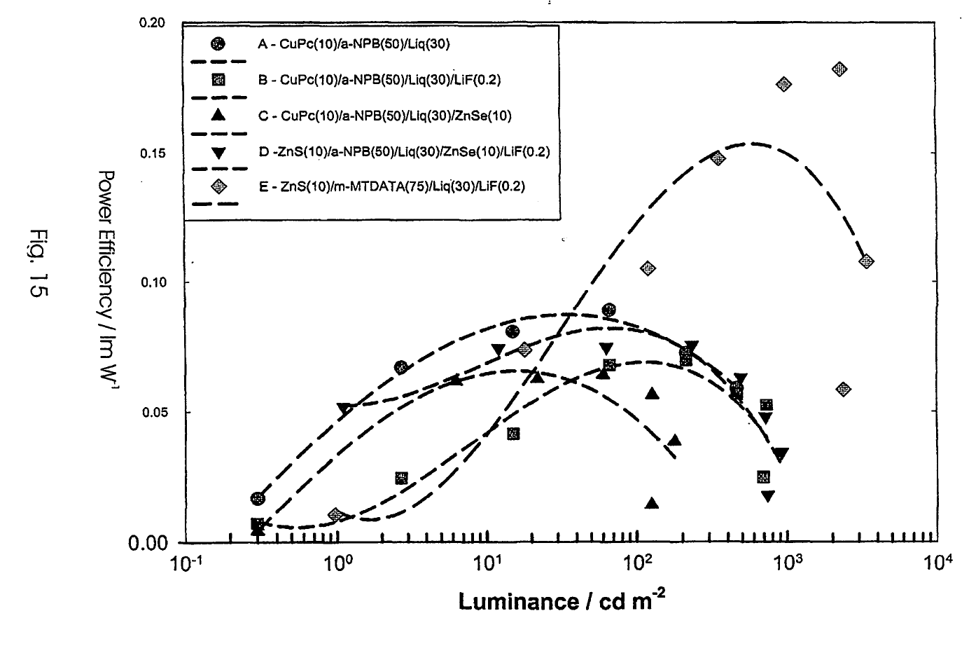

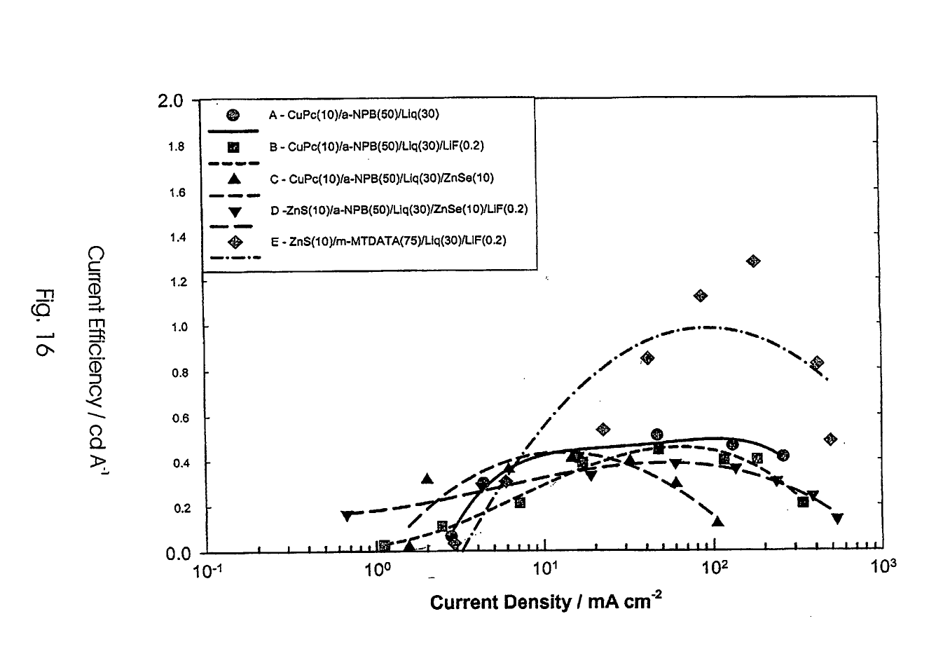

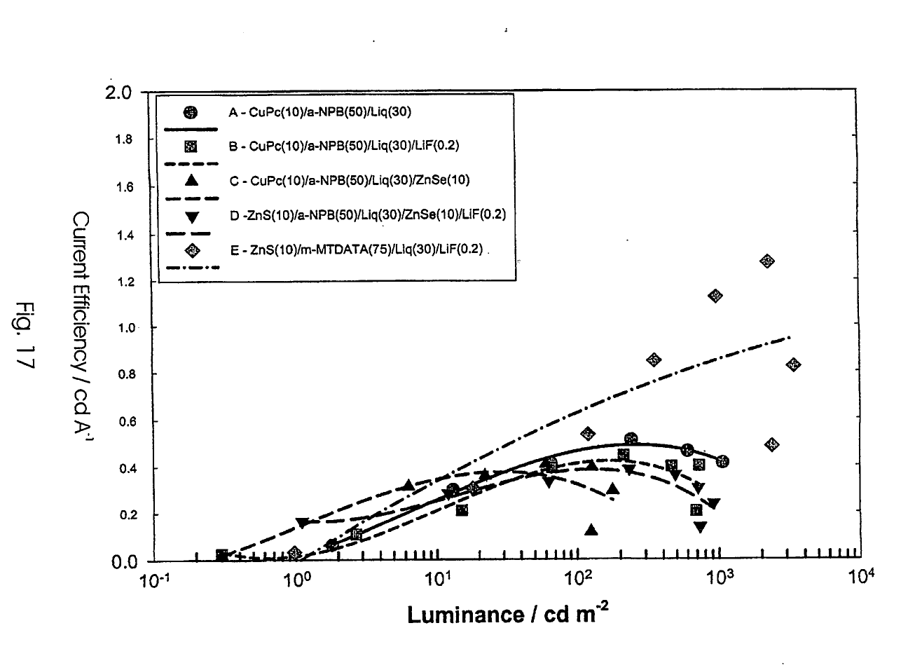

The electroluminescent properties are shown in FIGS. 12 to 17.

### EXAMPLE 2

Devices were fabricated as in Example 1 with the structures

ITO/ZnTpTp(20 nm)/α-NPB(50)/Zrq4:DPQA/(40:0.1)/Zrq4(20)/LiF(0.5)/Al
and
ITO/ZnTpTp(20 nm)/ZnS(20)/α-NPB(30)/Zrq4:DPQA/(40:0.1)/Zrq4(20)/LiF(0.5)/Al
where ZnTpTp is

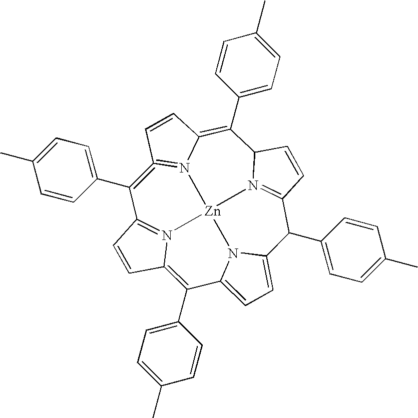

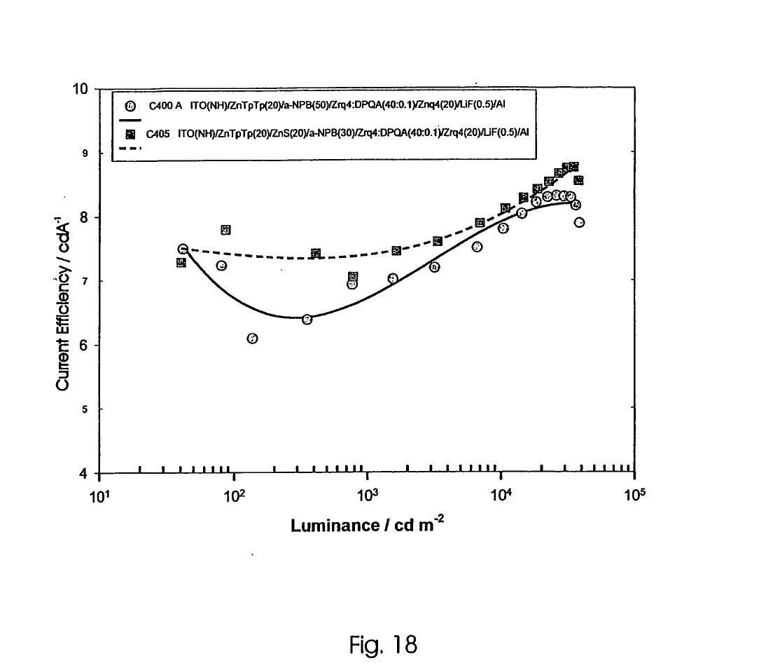

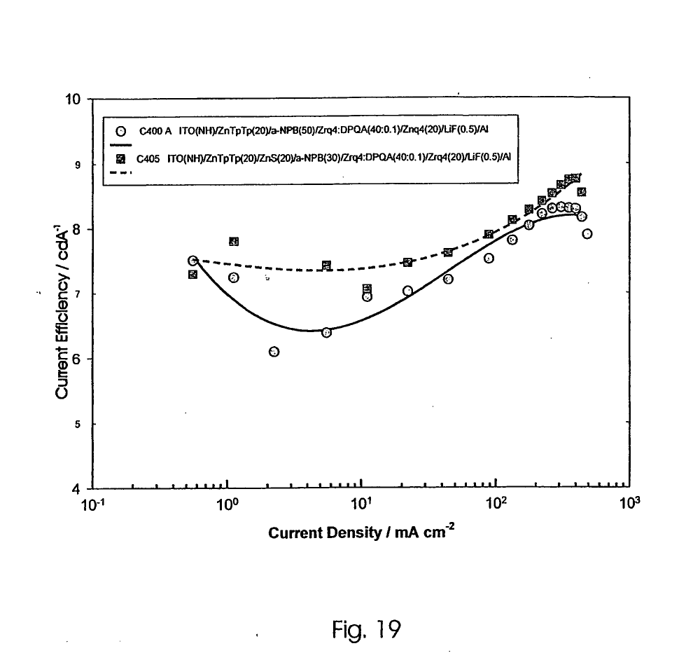

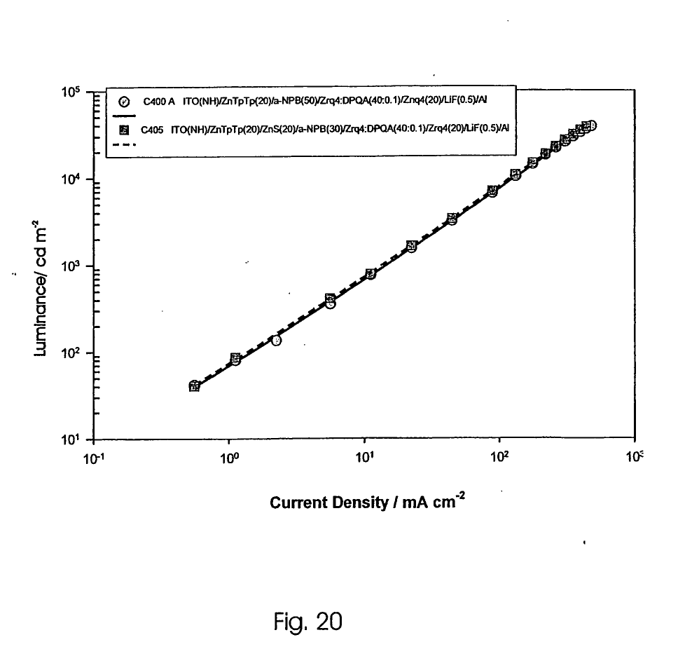

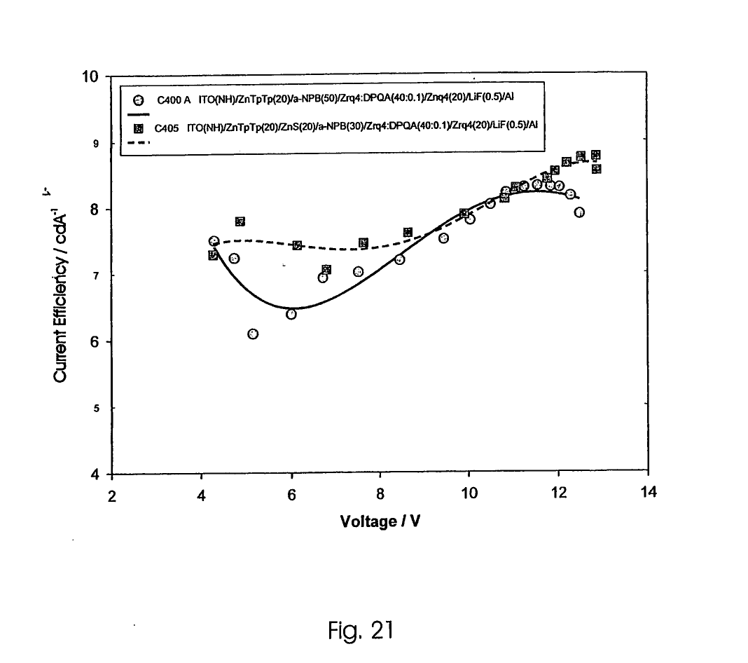

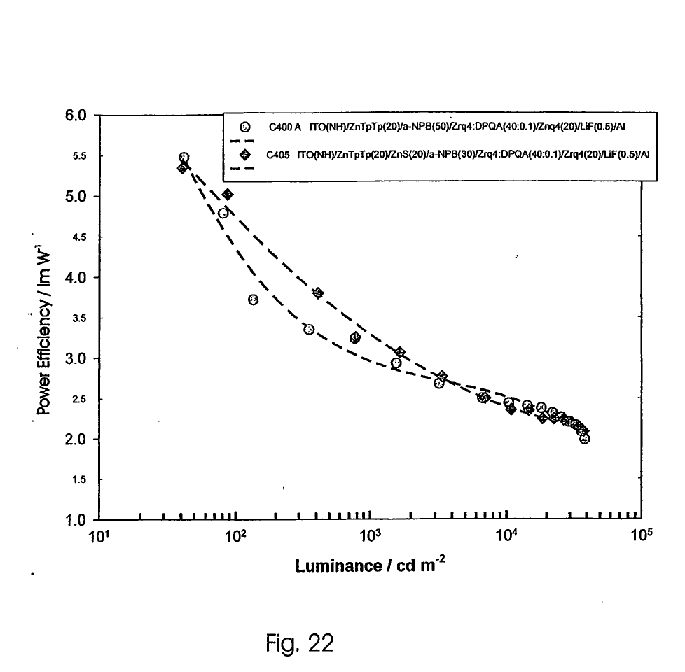

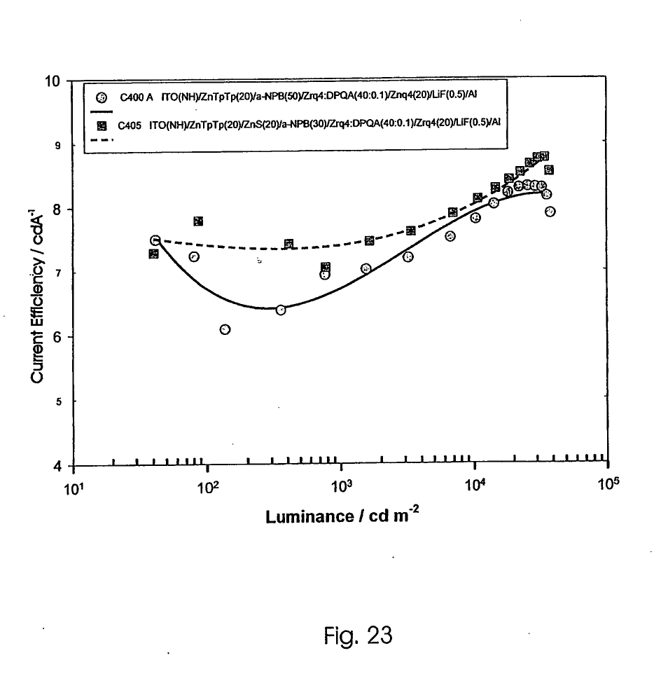

Zrq4 is zirconium quinolate and DPQA is diphenylquinacridine and their electroluminescent properties measured as in Example 1 and the results shown in FIGS. 18 to 23.

The devices were fabricated using an Edwards coater which resulted in the layers being of greater thickness than would be possible with other devices such as a Solciet Machine, ULVAC Ltd. Chigacki, Japan. This required higher voltages being required to obtain the performance readings. With other coating devices lower voltages could be used.

The examples show that inorganic HTLS and ETLs can be used which would not have the disadvantages of thermally induced deformation of the organic layers in organic HTLs and ETLs.

1-22. (canceled)

23. An electroluminescent device comprising: (i) a first electrode; (ii) a second electrode; (iii) a layer of an inorganic charge transporting material positioned between said first and second electrodes; and (iv) a layer of an organic electroluminescent material also positioned between said first and second electrodes.

24. An electroluminescent device comprising: (i) a first electrode that functions as an anode; (ii) a second electrode that functions as a cathode; and, located between said first and second electrodes, (iii) a layer of an inorganic hole transporting material (HTL) which is a p-type semiconductor; (iv) a layer of an organic electroluminescent material; and (v) a layer of an inorganic electron transporting material (ETL) which is an n-type semiconductor.

25. The device of claim 24, wherein the n-type semiconductor is selected from the group consisting of n-CdSe, n-ZnSe, n-CdTe, n-ITO (indium tin oxide), n-GaAs and n-Si.

26. The device of claim 25, wherein the p-type semiconductor is selected from the group consisting of p-ZnS, p-ZnO, p-CdTe, p-InP, p-GaAs and p-Si.

27. The device of claim 24, wherein the thickness of the layer of hole transporting material and the thickness of the layer of electron transporting material range from about 2 to 100 nm.

28. The device of claim 24, wherein the thickness of the layer of hole transporting material and the thickness of the layer of electron transporting material range from about 10 to 50 nm.

29. The device of claim 23, wherein the electroluminescent material is selected from the group consisting of:
(a) an organometallic complex having the general chemical formula 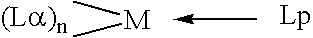
where: Lα and Lp are organic ligands; M is selected from the group consisting of rare earth metals, transition metals, lanthanide series elements and actinide series elements; n is the valence state of the metal M; and further wherein the ligands La are the same or different; and, optionally, wherein there are a plurality of ligands Lp which can be the same or different;
(b) an organometallic complex having a general chemical formula selected from the group consisting of (Lₙ)ₙM₁M₂ and (Lₙ)ₙ M₁M₂ (Lₚ), where: Lₙ is the same as Lα; Lₚ is a neutral ligand; M₁ is selected from the group consisting of rare earth metals, transition metals, lanthanide series elements and actinide series elements; M₂ is a non rare earth metal; and n is the combined valence state of M₁ and M₂;
(c) a binuclear, trinuclear or polynuclear organometallic complex:
(1) having a general chemical formula selected from the group consisting of 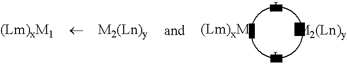
where: L is a bridging ligand; M₁ is a rare earth metal; M₂ is M₁ or a non rare earth metal; Lm and Ln are the same or different organic ligands Lα as defined above; x is the valence state of M₁; and y is the valence state of M₂; or
(2) having a general chemical formula selected from the group consisting of 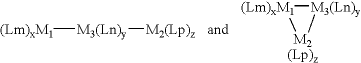
where: M₁, M₂ and M₃ are the same or different rare earth metals; Lm, Ln and Lp are organic ligands Lα; x is the valence state of M₁; y is the valence state of M₂; z is the valence state of M₃; and Lp can be the same as Lm and Ln or different; or
(3) having a general chemical formula selected from the group consisting of 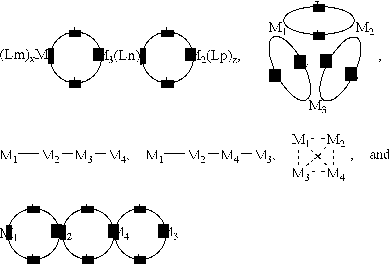
where: M₄ is M₁; L is a bridging ligand; and in which the rare earth metals and the non rare earth metals can be joined together by a metal-to-metal bond and/or via an intermediate bridging atom, ligand or molecular group, or in which there are more than three metals joined by metal-to-metal bonds and/or via intermediate ligands;
(d) a metal quinolate;
(e) an electroluminescent non rare earth metal complex;
(f) a metal complex having the general chemical formula 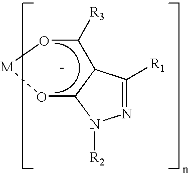
where: M is a metal other than a rare earth metal, a transition metal, a lanthanide series element or an actinide series element; n is the valency of M; R₁, R₂ and R₃, which may be the same or different, are independently selected from the group consisting of hydrogen; hydrocarbyl groups; substituted and unsubstituted aliphatic groups; substituted and unsubstituted aromatic, heterocyclic and polycyclic ring structures; fluorocarbons; halogens; thiophenyl groups; and nitrile groups; alternatively, R₁ and R₃ can also form ring structures, and R₁, R₂ and R₃ can be copolymerisable with a monomer;
(g) a diiridium compound having the general chemical formula 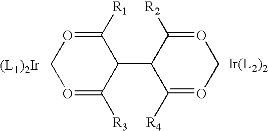
where: R₁, R₂, R₃ and R₄ can be the same or different, and are independently selected from the group consisting of hydrogen and substituted and unsubstituted hydrocarbyl groups;
(h) a boron compound having the general chemical formula 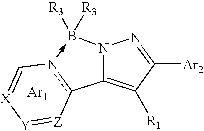
wherein: (1) Ar₁ represents a group selected from unsubstituted and substituted monocyclic or polycyclic heteroaryls having a ring nitrogen atom for forming a coordination bond to boron and, optionally, one or more additional ring nitrogen atoms, subject to the proviso that nitrogen atoms do not occur in adjacent positions; X and Z are selected from carbon and nitrogen; and Y is carbon or, optionally, nitrogen if neither of X and Z is nitrogen; further wherein substituents, if present, are selected from substituted and unsubstituted hydrocarbyl, substituted and unsubstituted hydrocarbyloxy, fluorocarbon, halo, nitrile, amino alkylamino, dialkylamino and thiophenyl; (2) Ar₂ represents a group selected from monocyclic and polycyclic aryl and heteroaryl, optionally substituted with one or more substituents selected from substituted and unsubstituted hydrocarbyl, substituted and unsubstituted hydrocarbyloxy, fluorocarbon, halo, nitrile, amino, alkylamino, dialkylamino and thiophenyl; (3) R₁ represents hydrogen or a group selected from substituted and unsubstituted hydrocarbyl, halohydrocarbyl and halo; and (4) R₂ and R₃ each independently represent a moiety selected from alkyl, cycloalkyl, cycloalkylalkyl, haloalkyl, halo and monocyclic, polycyclic, aryl, heteroaryl, aralkyl and heteroaralkyl, optionally substituted with one or more moieties selected from alkyl, cycloalkyl, cycloalkylalkyl, haloalkyl, aryl, aralkyl, alkoxy, aryloxy, halo, nitric, amino, alkylamino and dialkylamino;
(i) a compound having a general chemical formula selected from the group consisting of 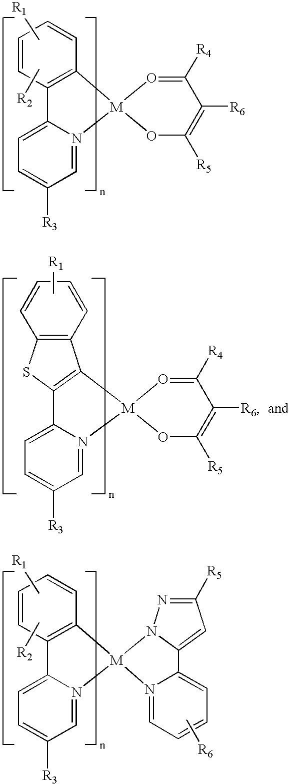
where: R₁, R₂, R₃, R₄, R₅ and R₆ can be the same or different and are independently selected from the group consisting of hydrogen; substituted and unsubstituted hydrocarbyl groups; substituted and unsubstituted aromatic, heterocyclic and polycyclic ring structures; fluorocarbons; halogens; and thiophenyl groups; alternatively, R₁, R₂ and R₃ can form substituted and unsubstituted fused aromatic, heterocyclic and polycyclic ring structures and can be copolymerisable with a monomer, while R₄ and R₅ can be the same or different and are independently selected from the group consisting of hydrogen; substituted and unsubstituted hydrocarbyl groups; substituted and unsubstituted aromatic, heterocyclic and polycyclic ring structures; fluorocarbons; halogens; and thiophenyl groups; alternatively, R₁ R₂ and R₃ can form substituted and unsubstituted fused aromatic, heterocyclic and polycyclic ring structures and can be copolymerisable with a monomer; M is selected from the group consisting of ruthenium, rhodium, palladium, osmium, iridium and platinum; and n+2 is the valency of M; and
(j) a compound having the general chemical formula 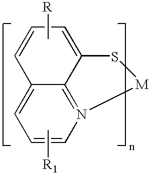
where: M is a metal; n is the valency of M; R and R₁ can be the same or different and are independently selected from the group consisting of hydrogen; substituted and unsubstituted hydrocarbyl groups; substituted and unsubstituted aromatic, heterocyclic and polycyclic ring structures; fluorocarbons; halogens; thiophenyl groups; cyano groups; substituted and unsubstituted hydrocarbyl groups; and substituted and unsubstituted aliphatic groups.

30. The device of claim 29, wherein the electroluminescent material is a metal quinolate selected from the group consisting of aluminum quinolate, lithium quinolate and zirconium quinolate.

31. The device of claim 29, wherein the electroluminescent material is an aluminum, magnesium, zinc or scandium complex.

32. The device of claim 29, wherein the electroluminescent material is a β-diketone complex.

33. The device of claim 29, wherein the electroluminescent material is selected from the group consisting of Al(DBM)₃, Zn(DBM)₂, Mg(DBM)₂ and Sc(DBM)₃, where (DBM) represents the chemical group Tris-(1,3-diphenyl-1-3-propanedione).
